(19) United States
(12) Patent Application Publication
(10) Pub. No.: US 2015/0062070 A1
(43) Pub. Date: Mar. 5, 2015

(54) ACTIVE-TYPE STYLUS PEN

(71) Applicant: Te-Hsiang FANG, San Chung City (TW)

(72) Inventor: Te-Hsiang FANG, San Chung City (TW)

(21) Appl. No.: 14/195,468

(22) Filed: Mar. 3, 2014

(30) Foreign Application Priority Data
Sep. 2, 2013 (TW) 102216467

(51) Int. Cl. G06F 3/0354; G06F 3/044

(52) U.S. Cl. CPC G06F 3/03545; G06F 3/044
USPC 345/174

(57) ABSTRACT

An active-type stylus pen for manipulating a capacitive type touch screen, comprises a main housing of a sleeve shape, a printed circuit board, a front-end means, and an ON/OFF switch device, in which, a pen-tip receives electric signals from the printed circuit board and provides the electric signals to the touch screen when touching the touch screen. The ON/OFF switch device is disposed in an end portion of the active-type stylus pen and connected to the main housing. A switch mechanism is accommodated within an axial inner space of the ON/OFF switch device for selectively allowing the active-type stylus pen to be electrically-on or electrically-off.

### CROSS-REFERENCE TO RELATED APPLICATION

This utility application claims priority to Taiwan Application Serial Number 102216467, filed Sep. 2, 2013, which is incorporated herein by reference.

### BACKGROUND OF THE INVENTION

1. Field of the Invention

The invention relates to a stylus pen used for inputting commands to a touch panel, and particularly to a power switch device of an active-type stylus pen.

2. Description of the Prior Art

A stylus pen, also referred to as stylus, touch pen, touch screen pen or touch control pen, is used for precisely manipulating a small portable electronic device, such as smartphone, tablet personal computer (PC), and so on.

Stylus pens can be substantially classified into passive type and active type. The active-type stylus pen has a battery and a printed circuit board. The electric circuit generates electric signals, such as electric waves, electric currents or electric voltages. When a pen tip of the stylus pen touches the touch screen, the electric signals are received by the touch screen to accomplish the touch control performances.

When using a conventional active-type stylus pen, a user may unintentionally not push the stylus pen against the touch screen such that the front-end of the stylus pen is off the touch screen, resulting in an unwanted operation, and it causes problems in command input.

### SUMMARY OF THE INVENTION

Accordingly, to solve the aforesaid problems, an active-type stylus pen for manipulating a capacitive type touch screen is provided according to embodiments of the present invention. The stylus pen comprises an ON/OFF switch device, a main housing and a front-end means. The ON/OFF switch device is disposed in an end portion of the active-type stylus pen. A switch mechanism is accommodated within an axial inner space of the ON/OFF switch device. The switch mechanism is capable of selectively allowing the active-type stylus pen to be electrically-on or electrically-off. The main housing is of a sleeve shape and connected to the ON/OFF switch device. A first accommodation space is provided within the main housing for accommodating a battery. The front-end means comprises a housing connected to the main housing. A second accommodation space is provided within the housing along an axial direction for accommodating at least a pen-tip. The front-end means has an opening at a first end to allow the pen-tip to be exposed from the housing. The pen-tip receives the electric signal at a second end. The pen-tip may stably provide the electric signal when touching the touch screen.

The pen-tip may further comprise an electrically-conductive member and an electrically-conductive rubber. The electrically-conductive rubber covers the electrically-conductive member. The electrically-conductive member is in a rod shape and has a head portion and a neck portion, and a diameter of the neck portion is less than a diameter of the head portion.

According to another embodiment of the present invention, an active-type stylus pen for manipulating a capacitive type touch screen is provided. The stylus pen comprises a main housing, a printed circuit board, and a front-end means. The main housing is of a sleeve shape and connected to an ON/OFF switch device. A first accommodation space is provided within the main housing for accommodating a battery. The printed circuit board is for providing an electric signal. The front-end means comprises a housing connected to the main housing. A second accommodation space is provided within the housing along an axial direction for accommodating at least a pen-tip. The front-end means has an opening at a first end to allow the pen-tip to be exposed from the housing. The pen-tip receives the electric signal at a second end. The pen-tip may stably provide the electric signal when touching the touch screen. The ON/OFF switch device is disposed in an end portion of the active-type stylus pen. A switch mechanism is accommodated within an axial inner space of the ON/OFF switch device. The switch mechanism is capable of selectively allowing the active-type stylus pen to be electrically-on or electrically-off. The switch mechanism comprises a back/forth moving means. The back/forth moving means comprises a stator and a screw capable of moving forward or backward. An inclined groove is formed on the stator. A pillar is disposed on the screw. When the pillar is selectively located at the highest position of the inclined groove, the back/forth moving means is at a first dead point.

The advantage and spirit of the invention may be understood by the following recitations together with the appended drawings.

### BRIEF DESCRIPTION OF THE APPENDED DRAWINGS

FIG. 1 is a schematically sectional view illustrating a stylus pen according to an embodiment of the invention.

FIG. 2 is a schematically sectional view illustrating a front-end means of a stylus pen according to an embodiment of the invention.

FIG. 3A is a schematically sectional view illustrating an ON/OFF switch device of the stylus pen in a first status according to an embodiment of the invention.

FIG. 3B is a schematically sectional view illustrating an ON/OFF switch device of the stylus pen in a second status according to an embodiment of the invention.

### DETAILED DESCRIPTION OF THE INVENTION

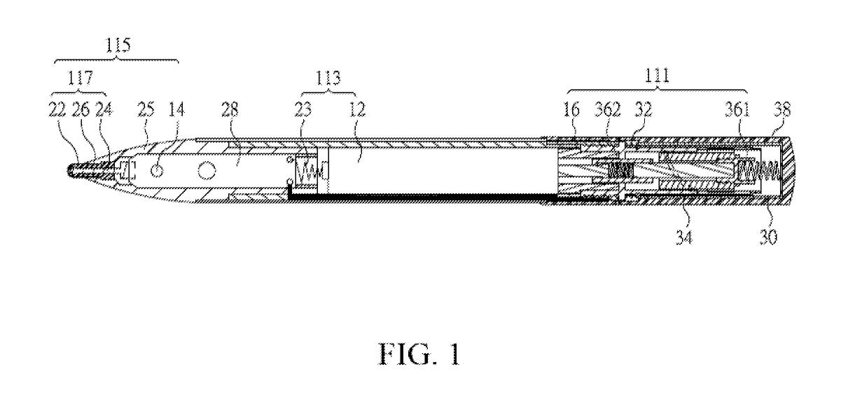

As shown in FIG. 1, an active-type stylus pen for manipulating a capacitive type touch screen according to an embodiment of the present invention comprises an ON/OFF switch device 111, a main housing 113, a printed circuit board 28 and a front-end means 115. The printed circuit board 28 may be disposed within the accommodation space of the main housing 113 or the front-end means 115.

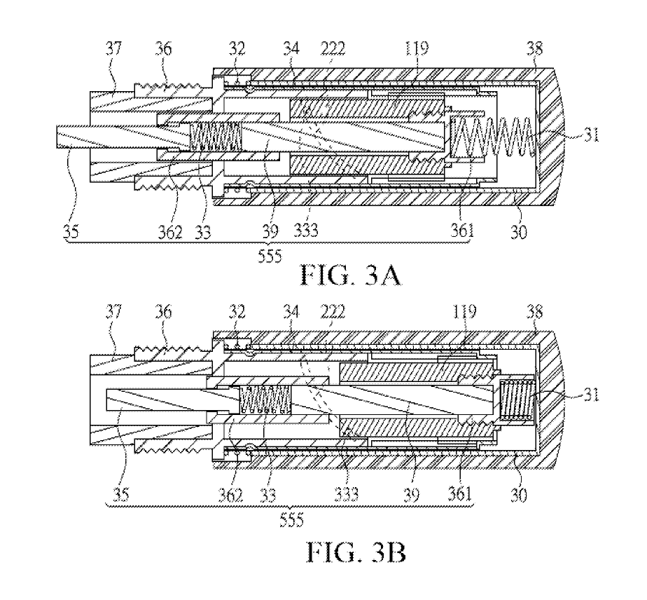

The ON/OFF switch device 111 is disposed in an end portion of the active-type stylus pen. An axial space is formed inside the ON/OFF switch device 111 and referred to as “axial inner space.” A switch mechanism is accommodated within the axial inner space. The switch mechanism is capable of selectively allowing the active-type stylus pen to be electrically-on or electrically-off. It is further described in detail in the description referring to FIG. 3A and FIG. 3B.

The main housing 113 is of a sleeve shape and connected to ON/OFF switch device 111. A first accommodation space is provided within the main housing 113 for accommodating a battery 12, a first electrically-conductive spring 23 or the printed circuit board 28. The battery 12 provides electricity to the printed circuit board 28 through the first electrically-conductive spring 23. Relative electric circuit and LED light source 14 may be disposed on the printed circuit board 28. The printed circuit board 28 is used for generating relative electric signals, such as electric waves, and selectively turning on the LED light source 14.

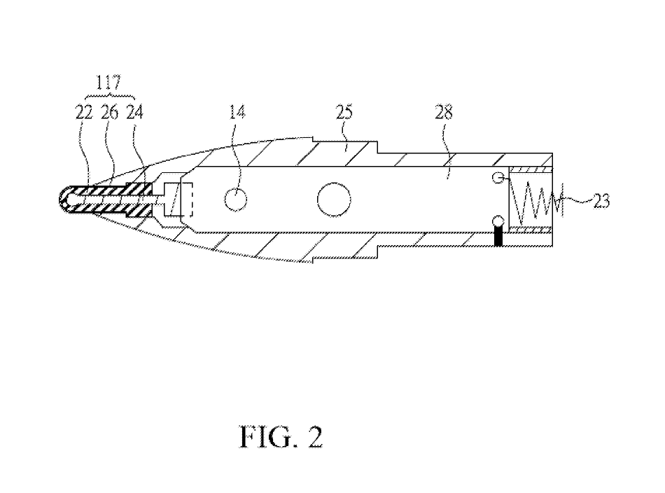

As shown in FIG. 1 or FIG. 2, the front-end means 115 comprises a housing 25 connected to the main housing 113. A second accommodation space is provided within the housing 25 along an axial direction for accommodating at least a pen-tip 117 or the printed circuit board 28. The front-end means 115 has an opening at an end to allow the pen-tip 117 to be exposed from the housing 25. The pen-tip 117 receives the electric signals at another end. The pen-tip 117 may stably provide the electric signal when touching the touch screen. The pen-tip 117 may further comprise an electrically-conductive member 24 and an electrically-conductive rubber 22. The electrically-conductive rubber 22 covers the electrically-conductive member. The electrically-conductive member 24 is in a rod shape and has a head portion and a neck portion. A diameter of the neck portion is less than a diameter of the head portion, as shown in FIG. 2, so as to reduce the magnitude of the signals generated from the neck portion and prevent the signals, such as electric waves, generated from the neck portion from being detected by the touch screen, such that unwanted operations can be prevented.

The pen-tip 117 further includes a shoulder portion. An end of the shoulder portion is against correspondingly an end of the electric circuit board 28, as shown in FIG. 2.

According to another embodiment, the housing 25 and the main housing 113 may be formed monolithically to be a single housing. This embodiment is also scoped by the present invention.

The stylus pen may further includes an electrically-conductive fabric 26 for covering the electrically-conductive rubber 22, so as to provide stable and precise electric signals for operations.

As shown in FIG. 2, relative electric signals, such as electric wave signals, may go through the electrically-conductive rubber 22, the electrically-conductive member 24 and/or the electrically-conductive fabric 26 and be emitted from the pen-tip 117. If the electrically-conductive rubber 22 (or the electrically-conductive fabric 26) is touching screen when the signals are emitted, the signals can be detected by the electric circuit of the touch screen, so as to achieve the objective and the performance as a role of interface in the mobile electronic device.

According to the embodiment as shown in FIG. 2, the electric circuit board 28 is accommodated within accommodation space of the front-end means 115. A shoulder portion of the electrically-conductive member 24 is against correspondingly an end of the electric circuit board 28 to receive signals.

As shown in FIG. 1 and FIG. 2, the front-end means 115 may include a first electrically-conductive spring 23 accommodated within a second accommodation space. The first electrically-conductive spring 23 pushes against another end of the printed circuit board 28 and an electrode of the battery 12 respectively for transmitting the electric power from the battery 12 to the printed circuit board 28.

As shown in FIG. 3A and FIG. 1, the ON/OFF switch device 111 includes a back/forth moving means 555, a metal inner tube 30, a plastic outer tube 38 and a plastic jacket 16. The plastic jacket 16 is threaded and screwed into or onto the threaded stator 36 for connection. The back/forth moving means 555 includes a first electrically-conductive metal depressor 35, a second electrically-conductive spring 33, a second metal depressor 39, a first metal support 361, a second metal support 362, a third electrically-conductive spring 31 and a screw 119 capable of moving forward or backward.

When a user rotates the plastic outer tube 38 to a certain position for connection, as shown in FIG. 3A, the screw 119 moves forward, the pillar 333 is at the highest position of the inclined groove 222, and the back/forth moving means 555 is at a first dead point, such that the first electrically-conductive metal depressor 35 push the battery 12. Such situation as a whole is an electrically-on status and can be as illustrated by FIG. 3A. The LED light source 14 may be turned on and the electrically-conductive rubber 22 will transmit the electric signals. Meantime, the third electrically-conductive spring 31 is in a relax status.

When a user rotates the plastic outer tube 38 to leave the connection position and to reach another certain position, as shown in FIG. 3B, the screw 119 moves backward, the pillar 333 is at the lowest position of the inclined groove 222, and the back/forth moving means 555 is at a second dead point, such that the first electrically-conductive metal depressor 35 does not contact the battery 12 to push it. Such situation as a whole is an electrically-off status. The LED light source 14 may be turned off and the electrically-conductive rubber 22 does not transmit electric signals. Meantime, the third electrically-conductive spring 31 is in a compression status.

According to an embodiment, the inclined groove 222 is formed on the stator 36, and the pillar 333 is disposed on the screw 119, as shown in FIG. 3A and FIG. 3B. Alternatively, the inclined groove 222 may be formed on the screw 119 capable of moving forward or backward, and the pillar 333 is disposed on the stator 36. It is also scoped by the present invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An active-type stylus pen for manipulating a capacitive type touch screen, comprising:
a main housing of a sleeve shape, wherein a first accommodation space is provided within the main housing for accommodating a battery;
a printed circuit board for providing an electric signal;
a front-end means comprising a housing connected to the main housing, wherein a second accommodation space is provided within the housing along an axial direction for accommodating at least a pen-tip, the front-end means has an opening at a first end to allow the pen-tip to be exposed from the housing, the pen-tip receives the electric signal at a second end, and the pen-tip provides the electric signal when touching the touch screen; and
an ON/OFF switch device being disposed in an end portion of the active-type stylus pen and connected to the main housing, a switch mechanism is accommodated within an axial inner space of the ON/OFF switch device for selectively allowing the active-type stylus pen to be electrically-on or electrically-off, the switch mechanism comprises a back/forth moving means comprising a stator and a screw capable of moving forward or backward, an inclined groove being formed on the stator, and a pillar being disposed on the screw, and when the pillar is selectively located at a highest position of the inclined groove, the back/forth moving means is at a first dead point.

2. The stylus pen of claim 1, wherein the touch pen-tip comprises an electrically-conductive member and an electrically-conductive rubber for covering the electrically-conductive member, wherein the electrically-conductive member is in a rod shape and comprises a head portion and a neck portion, and a diameter of the neck portion is less than a diameter of the head portion.

3. The stylus pen of claim 1, wherein the stylus pen further comprises a first electrically-conductive spring disposed within the second accommodation space and pushing against a third end of the printed circuit board and an electrode of the battery respectively for transmitting the electric power from the battery to the printed circuit board.

4. The stylus pen of claim 1, when a user rotates the ON/OFF switch device, the stylus pen is selectively electrically-off or electrically-on.

5. The stylus pen of claim 1, wherein the electric signal is an electric wave.

6. The stylus pen of claim 1, wherein the printed circuit board is disposed within the first accommodation space of the main housing or the second accommodation space of the front-end means.

7. The stylus pen of claim 2, wherein the stylus pen further comprises an electrically-conductive fabric for covering the electrically-conductive rubber.

8. An active-type stylus pen for manipulating a capacitive type touch screen, comprising:
an ON/OFF switch device disposed in an end portion of the active-type stylus pen, wherein a switch mechanism is accommodated within an axial inner space of the ON/OFF switch device for selectively allowing the active-type stylus pen to be electrically-on or electrically-off, wherein the switch mechanism comprises a back/forth moving means comprising a stator and a screw allowed to move forward or backward, an inclined groove being formed on the stator, and a pillar being disposed on the screw, and when the pillar is selectively located at a highest position of the inclined groove, the back/forth moving means is at a first dead point;
a printed circuit board for providing an electric signal; and
a front-end means comprising a housing substantially of a sleeve shape and connected to the ON/OFF switch device, wherein a first accommodation space is provided within the housing for accommodating a battery, a second accommodation space is provided within the front-end means along an axial direction for accommodating at least a pen-tip, the front-end means has an opening at a first end to allow the pen-tip to be exposed from the housing, the pen-tip receives the electric signal at a second end, and the pen-tip provides the electric signal when touching on the touch screen.

9. The stylus pen of claim 8, wherein the pen-tip comprises an electrically-conductive member and an electrically-conductive rubber covering the electrically-conductive member, the electrically-conductive member is in a rod shape and has a head portion and a neck portion, and a diameter of the neck portion is less than a diameter of the head portion.

10. The stylus pen of claim 9, the housing further comprising a main housing for connecting to the ON/OFF switch device, and the first accommodation space is provided within the main housing for accommodating the battery.
